(19) United States
(12) Patent Application Publication
(10) Pub. No.: US 2017/0372579 A1
(43) Pub. Date: Dec. 28, 2017

(54) SENSORY DEVICE FOR A MOTOR VEHICLE

(71) Applicant: Tammy Hall Williamson, Heflin, AL (US)

(72) Inventor: Tammy Hall Williamson, Heflin, AL (US)

(21) Appl. No.: 15/631,778

(22) Filed: Jun. 23, 2017

Related U.S. Application Data
(60) Provisional application No. 62/354,112, filed on Jun. 23, 2016.

(51) Int. Cl. G08B 21/02; B60R 1/04; B60R 25/20

(52) U.S. Cl. CPC G08B 21/0205; B60R 25/20; G08B 21/0277; B60R 1/04; B60R 2325/205; B60R 2325/101

(57) ABSTRACT

A sensory device for a motor vehicle is a system for automatically preventing the driver of a vehicle from forgetting and leaving an infant in a car seat when exiting the vehicle. The system uses the mirror of a vehicle to house many of the functions for scanning the vehicle and detecting various types of sensitive indicators that a person is still in the vehicle. A transmitter is able to transmit a signal using various methods, to receivers such as smart cell phones to alert the driver and/or other individuals either in the vehicle or otherwise, that an infant was left behind.

### CROSS-REFERENCE TO RELATED APPLICATION

The present application is related to and claims priority from prior provisional application Ser. No. 62/354,112, filed Jun. 23, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of vehicle driver alert devices and more specifically relates to sensory device for a motor vehicle.

### 2. Description of the Related Art

Families travel together in vehicles to go to many places such as on vacations, shopping, restaurants, and innumerous other locations. Many of these families have children and quite often these children are infants. During travel, most family members get involved in conversation and become preoccupied scarcely playing attention to the travel home. After arriving, the family members exit the vehicle carrying shopping bags, school books, and other items into the house. In recent years such a common occurrence has turned tragic because with increasing frequency sleeping infants are forgotten in their car seats and die from exposure. With the windows rolled up during summer, the interiors of cars can reach 140 degrees F., far too hot for helpless infants to survive. There have been recent incidents where distracted parents had forgotten to drop their infant child off at the babysitter on the way to work, leaving the sleeping infant in the car seat, only to discover later that the infant had died from exposure. Parents that have had such a tragedy occur in their life never completely recover. These tragedies are never intentional but in most cases the parent gets charged with negligent homicide, increasing the tragedy and changing the life of the parent even further. A change of routine or a very stressful job, such as is very common in the modern workplace, sets the stage for such a tragedy to occur. An innovation that is able to prevent this type of disaster is needed.

Various attempts have been made to solve the above-mentioned problems, but as of yet, none of the prior art taken either singly or in combination is seen to solve the problem.

Ideally, a vehicle driver alert device should provide convenience and fail safe functionality, and yet, would operate reliably and be manufactured at a modest expense. Thus, a need exists for a reliable sensory device for a motor vehicle to avoid the above-mentioned problems.

### BRIEF SUMMARY OF THE INVENTION

In view of the foregoing disadvantages inherent in the known vehicle driver alert devices art, the present invention provides a novel sensory device for a motor vehicle. The general purpose of the present invention, which will be described subsequently in greater detail, is to provide convenience and fail safe functionality of an automated car driver alert system.

The sensory device for a motor vehicle may comprise a main body that includes a front wall including a reflective surface, a body wall that detachably connects with the front wall and forms an interior volume therewith, a scanner member attached to the main body that is adapted to scan the interior volume of the motor vehicle, measure heat and detect motion therein, and send data signals to a processor member. Also, there preferably is included a processor member located within the interior volume of the main body that is electrically connected with the scanner member that is adapted to receive data signals from the scanner member, process the heat measurements, process motion detection signals, and send instructions to a transmitter. A transmitter is located within the interior volume of the main body that is electrically connected with and is adapted to receive instructions from the processor member.

The transmitter is adapted to send electronic signals to at least one external receiver to thereby perform certain desired functions. The desired functions are chosen from a list of functions consisting of turning on the engine of the motor vehicle, unlocking the doors of the motor vehicle, sounding an alarm, and sending an alert to at least one external receiver. A sound detector member is attached to the main body that is adapted to detect sound waves within the motor vehicle and send data signals to the processor member. A power source located within the interior volume of the main body is electrically connected to the scanner member, the processor member, the transmitter, and the sound detector member.

The power source preferably includes at least one battery member but may include a number of options in addition to the batter source. The transmitter includes BLUETOOTH technology as well as cellular functions. The external receiver(s) may be smart phones, land lines, radio, or other BLUETOOTH capable devices adapted to receive signals from the BLUETOOTH technology of the transmitter. There may be an alert button located upon the front wall of the device that is adapted to send an alert signal to the transmitter and thereby send an alert signal to the designated external receiver(s). An on/off button located upon the front wall is adapted to turn the sensory device on or off and there is an emergency service button located upon the front wall that is adapted to send an emergency service request signal to the transmitter and thereby send an emergency service request signal to a local emergency service system.

The sensory device for a motor vehicle may be offered as a combination of a motor vehicle and a sensory device for use within the motor vehicle. The combination may comprise a motor vehicle that includes as originally manufactured equipment, an interior passenger compartment, a windshield member, a power source, an engine member, and at least one door having an automatic locking mechanism. Also included is a sensory device comprising a main body having a front wall, having a reflective surface, a body wall detachably connected to the front wall that forms an interior volume therewith, a connector arm connected to a back portion of the body wall of the sensory device that is adapted to be releasably attached to the windshield member of the motor vehicle, a scanner member attached to the main body that is adapted to scan the interior passenger compartment of the motor vehicle, measure heat and detect motion therein, and send data signals to a processor member.

The processor member is located within the interior volume of the main body and is electrically connected with the scanner member. The processor member is adapted to receive data signals from the scanner member, process heat measurements, process motion detection signals, and send instructions to a transmitter located within the interior volume of the main body that is electrically connected with and is adapted to receive the instructions from the processor member. The transmitter is adapted to send electronic signals to at least one external receiver to perform desired functions. The power source of the motor vehicle is electrically connected with the scanner member, the processor member, the transmitter, and the sound detector member. The desired functions are chosen from a list of functions consisting of turning on the engine of the motor vehicle, unlocking at least one door of the motor vehicle, sounding an alarm, and sending an alert to at least one external receiver.

There may also be a sound detector member attached to the main body that is adapted to detect sound waves within the interior passenger compartment of the motor vehicle and send data signals to the processor member, and a power source located within the interior volume of the main body that is electrically connected with the scanner member. The processor member, the transmitter, and the sound detector member, is adapted to supply power to the scanner member, the processor member, the transmitter, and the sound detector member when the power source of the motor vehicle is unavailable. The power source may include at least one battery member.

The transmitter preferably includes BLUETOOTH technology. The external receiver(s) may be smart phones, land lines, radios, or other devices capable of receiving radio, BLUETOOTH, or cellular signals. There may be an alert button located upon the front wall of the device and adapted to send an alert signal to the transmitter to thereby send an alert signal to the specified external receiver(s), an on/off button located upon the front wall adapted to turn the sensory device on or off, and an emergency service button located upon the front wall adapted to send an emergency service request signal to the transmitter thereby sending an emergency service request signal to an emergency service system. The external receiver(s) preferably are smart phones that include a computer application adapted to alert the owner of the motor vehicle that a passenger is still remaining in their motor vehicle.

The present invention holds significant improvements and serves as a sensory device for a motor vehicle. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, sensory device for a motor vehicle, constructed and operative according to the teachings of the present invention.

FIG. 1 shows a perspective view illustrating an in-use condition of a sensory device for a motor vehicle according to an embodiment of the present invention.

FIG. 2 is a perspective view illustrating the sensory device for a motor vehicle according to an embodiment of the present invention of FIG. 1.

FIG. 3 is a perspective view illustrating the sensory device for a motor vehicle according to an embodiment of the present invention of FIG. 1.

FIG. 4 is a perspective view illustrating an external receiver of the sensory device for a motor vehicle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a vehicle driver alert devices and more particularly to a sensory device for a motor vehicle as used to improve the convenience and fail safe functionality of an automated car driver alert system.

Generally speaking, The sensory device for a motor vehicle is a system for automatically preventing the driver of a vehicle from forgetting and leaving an infant in a car seat when exiting the vehicle. The system uses the mirror of a vehicle to house many of the functions for scanning the vehicle and detecting various types of sensitive indicators that a person is still in the vehicle. A transmitter is able to transmit a signal using various methods, to receivers such as smart cell phones to alert the driver and/or other individuals either in the vehicle or otherwise, that an infant was left behind.

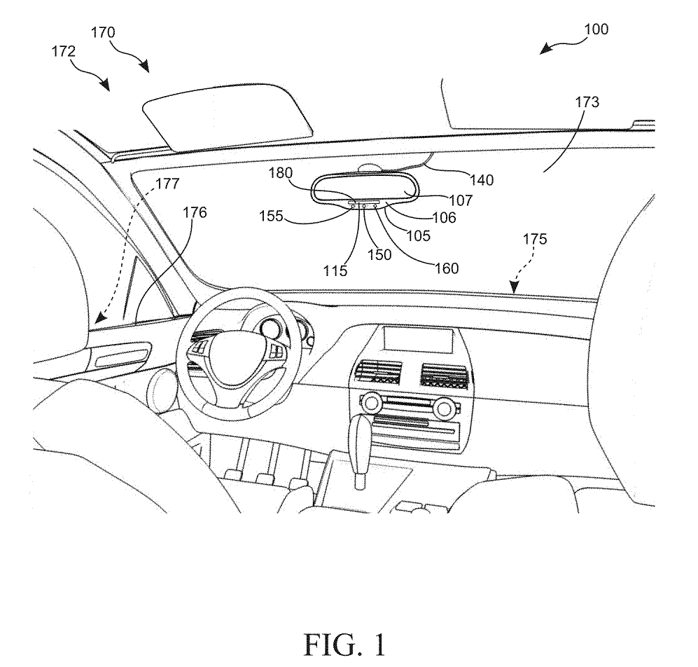

Referring to the drawings by numerals of reference there is shown in FIG. 1, shows a perspective view illustrating an in-use condition of sensory device for a motor vehicle 100 according to an embodiment of the present invention.

Sensory device for a motor vehicle 100 may be offered as a combination of a motor vehicle 170 and sensory device for a motor vehicle 100 or sensory device for a motor vehicle 100 may be offered separately as an aftermarket system for retrofitting an existing motor vehicle 170. When in combination, the combination may comprise motor vehicle 170, interior passenger compartment 172, windshield member 173, power source 140, engine member 175, and at least one door 176 having automatic locking mechanism 177. Also included is sensory device 180 comprising main body 105 having front wall 106, having reflective surface 107, body wall 108 detachably connected to front wall 106 that forms interior volume 109 therewith, connector arm 111 connected to back portion 112 of body wall 108 of sensory device 180 that is adapted to be releasably attached to windshield member 173 of motor vehicle 170, scanner member 115 attached to main body 105 that is adapted to scan interior passenger compartment 172 of motor vehicle 170, measure heat and detect motion therein, and send data signals to processor member 120.

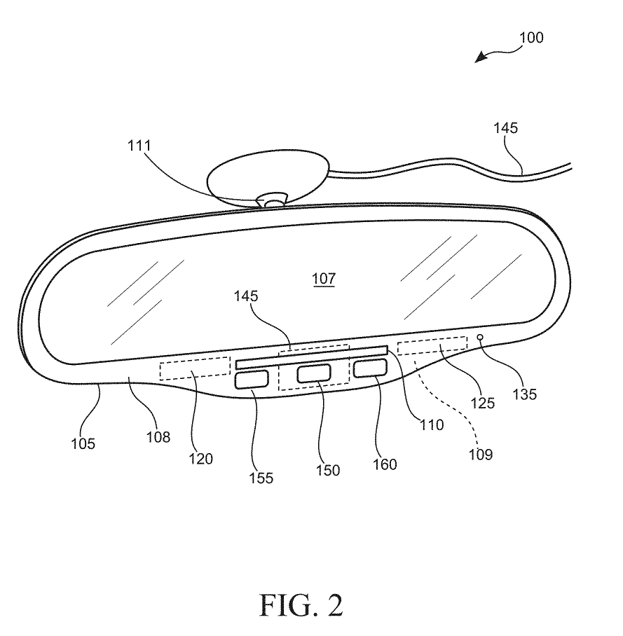

Referring now to FIG. 2, is a perspective view illustrating sensory device for a motor vehicle 100 according to an embodiment of the present invention of FIG. 1.

Sensory device for a motor vehicle 100 may comprise main body 105 that includes front wall 106 including reflective surface 107, body wall 108 that detachably connects with front wall 106 and forms interior volume 109 therewith scanner member 110 attached to main body 105 that is adapted to scan interior passenger compartment 172 of motor vehicle 170, measure heat and detect motion therein, and send data signals to processor member 120. Processor member 120 is located within interior volume 109 of main body 105 that is electrically connected with scanner member 115 that is adapted to receive data signals from scanner member 115, process the heat measurements, process motion detection signals, and send instructions to transmitter 125. Transmitter 125 is located within interior volume 109 of main body 105 that is electrically connected with and is adapted to receive instructions from processor member 120.

There may be alert button 150 located upon front wall 106 of main body 105 that is adapted to send an alert signal to transmitter 125 and thereby send an alert signal to the designated external receiver(s) 130. On/off button 155 located upon front wall 106 is adapted to turn sensory device 180 on or off and there is emergency service button 160 located upon front wall 106 that is adapted to send an emergency service request signal to transmitter 125 and thereby send an emergency service request signal to a local emergency service system.

Power source 140 of motor vehicle 170 is electrically connected with scanner member 110, processor member 120, transmitter 125, and sound detector member 135. The desired functions are chosen from a list of functions consisting of turning on engine member 175 of motor vehicle 170, unlocking at least one door 176 of motor vehicle 170, sounding an alarm, and sending an alert to at least one external receiver(s) 130.

There may also be sound detector member 135 attached to main body 105 that is adapted to detect sound waves within interior passenger compartment 172 of motor vehicle 170 and send data signals to processor member 120, and power source 140 located within interior volume 109 of main body 105 that is electrically connected with scanner member 115. Processor member 120, transmitter 125, and sound detector member 135, is adapted to supply power to scanner member 115, processor member 120, transmitter 125, and sound detector member 135 when power source 140 of motor vehicle 170 is unavailable. Power source 140 may include at least one battery member 145.

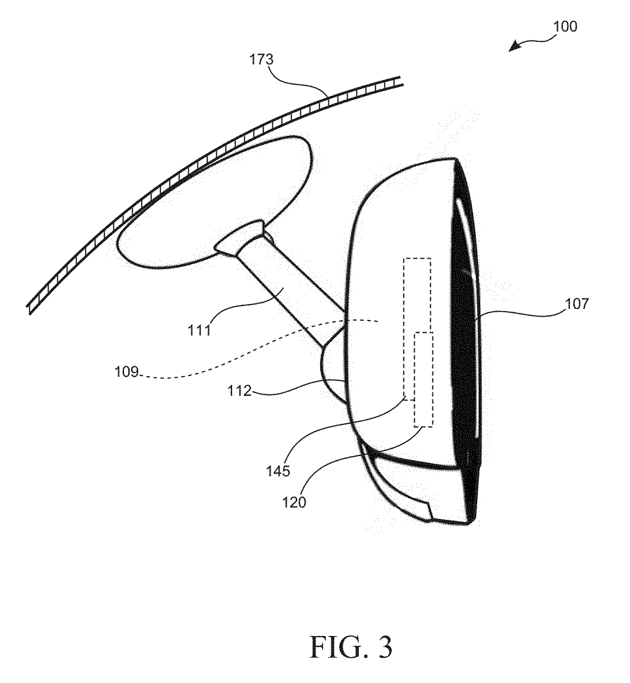

Referring now to FIG. 3, is a perspective view illustrating sensory device for a motor vehicle 100 according to an embodiment of the present invention of FIG. 1.

Processor member 120 is located within interior volume 109 of main body 105 and is electrically connected with scanner member 115. Processor member 120 is adapted to receive data signals from scanner member 115, process heat measurements, process motion detection signals, and send instructions to transmitter 125 located within interior volume 109 of main body 105 that is electrically connected with and is adapted to receive the instructions from processor member 120. Transmitter 125 is adapted to send electronic signals to at least one external receiver(s) 130 to perform desired functions.

Transmitter 125 is adapted to send electronic signals to at least one external receiver(s) 130 to thereby perform certain desired functions. The desired functions are chosen from a list of functions consisting of turning on engine member 175 of motor vehicle 170, unlocking door 176 of motor vehicle 170, sounding an alarm, and sending an alert to at least one external receiver(s) 130. Sound detector member 135 is attached to main body 105 that is adapted to detect sound waves within motor vehicle 170 and send data signals to processor member 120. Power source 140 located within interior volume 109 of main body 105 is electrically connected to scanner member 115, processor member 120, transmitter 125, and sound detector member 135.

Power source 140 preferably includes at least one battery member 145 but may include a number of options in addition to battery member 145. Transmitter 125 includes BLUETOOTH technology as well as cellular functions. External receiver(s) 130 may be smart phones, land lines, radio, or other BLUETOOTH capable devices adapted to receive signals from the BLUETOOTH technology of transmitter 125.

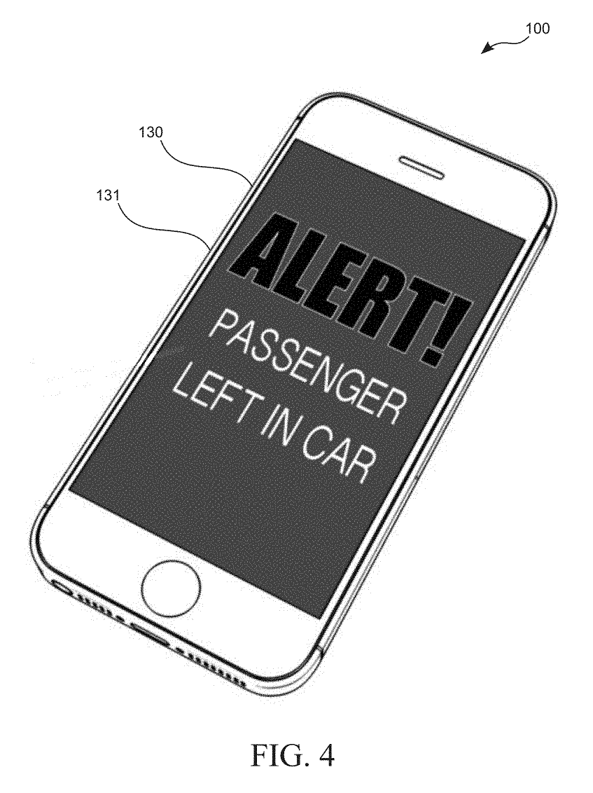

Referring now to FIG. 4, is a perspective view illustrating external receiver(s) 130 of sensory device for a motor vehicle 100 according to an embodiment of the present invention of FIG. 1.

Transmitter 125 preferably includes BLUETOOTH technology. External receiver(s) 130 may be smart phones 131, land lines, radios, or other devices capable of receiving radio, BLUETOOTH, or cellular signals. There may be an alert button located upon front wall 106 of main body 105 and adapted to send an alert signal to transmitter 125 to thereby send an alert signal to the specified external receiver(s) 130. On/off button 155 button located upon front wall 106 adapted to turn sensory device 180 on or off, and emergency service button 160 located upon front wall 106 adapted to send an emergency service request signal to transmitter 125 thereby sending an emergency service request signal to an emergency service system. External receiver(s) 130 preferably are smart phones 131 that include a computer application adapted to alert the owner of motor vehicle 170 that a passenger is still remaining in their motor vehicle 170.

Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A sensory device for a motor vehicle comprising:
a main body including:
a front wall;
wherein said front wall includes a reflective surface;
a body wall;
wherein said body wall detachably connects with said front wall and forms an interior volume therewith;
a scanner member;
wherein said scanner member is attached to said main body and is adapted to scan an interior volume of said motor vehicle, measure heat and detect motion therein, and send data signals to a processor member;
a processor member;
wherein said processor member is located within said interior volume of said main body and is electrically connected with said scanner member; and
wherein said processor member is adapted to receive said data signals from said scanner member, process said heat measurements, process motion detection signals, and send instructions to a transmitter; and
a transmitter;
wherein said transmitter is located within said interior volume of said main body and is electrically connected with and is adapted to receive said instructions from said processor member; and
wherein said transmitter is adapted to send electronic signals to at least one external receiver to thereby perform desired functions.

2. The sensory device of claim 1, wherein said desired functions are chosen from a list of functions consisting of turning on the engine of said motor vehicle, unlocking the doors of said motor vehicle, sounding an alarm, and sending an alert to said at least one external receiver.

3. The sensory device of claim 1, further comprising a sound detector member attached to said main body and is adapted to detect sound waves within said motor vehicle and send data signals to said processor member.

4. The sensory device of claim 3, further comprising a power source located within said interior volume of said main body and is electrically connected with said scanner member, said processor member, said transmitter, and said sound detector member.

5. The sensory device of claim 4, wherein said power source includes at least one battery member.

6. The sensory device of claim 1, wherein said transmitter includes BLUETOOTH technology.

7. The sensory device of claim 6, wherein said at least one external receiver is formed as a smart phone including BLUETOOTH technology adapted to receive signals from said BLUETOOTH technology of said transmitter.

8. The sensory device of claim 1, further comprising an alert button located upon said front wall and adapted to send an alert signal to said transmitter to thereby send an alert signal to said at least one external receiver; an on/off button located upon said front wall and adapted to turn said sensory device on or off; and an emergency service button located upon said front wall and adapted to send an emergency service request signal to said transmitter to thereby send an emergency service request signal to an emergency service system.

9. A combination of a motor vehicle and a sensory device for use within said motor vehicle, said combination comprising:
a motor vehicle including:
an interior passenger compartment;
a windshield member;
a power source;
an engine member; and
at least one door having an automatic locking mechanism; and
a sensory device comprising:
a main body including:
a front wall;
wherein said front wall includes a reflective surface;
a body wall;
wherein said body wall detachably connects with said front wall and forms an interior volume therewith;
a connector arm;
wherein said connector arm is connected to a back portion of said body wall of said sensory device, and is adapted to be releasably attached to said windshield member of said motor vehicle;
a scanner member;
wherein said scanner member is attached to said main body and is adapted to scan said interior passenger compartment of said motor vehicle, measure heat and detect motion therein, and send data signals to a processor member;
a processor member;
wherein said processor member is located within said interior volume of said main body and is electrically connected with said scanner member; and
wherein said processor member is adapted to receive said data signals from said scanner member, process said heat measurements, process motion detection signals, and send instructions to a transmitter; and
a transmitter;
wherein said transmitter is located within said interior volume of said main body and is electrically connected with and is adapted to receive said instructions from said processor member; and
wherein said transmitter is adapted to send electronic signals to at least one external receiver to thereby perform desired functions;
wherein said power source of said motor vehicle is electrically connected with said scanner member, said processor member, said transmitter, and said sound detector member.

10. The combination of claim 9, wherein said desired functions are chosen from a list of functions consisting of turning on said engine of said motor vehicle, unlocking said at least one door of said motor vehicle, sounding an alarm, and sending an alert to said at least one external receiver, and

11. The combination of claim 9, further comprising a sound detector member attached to said main body and is adapted to detect sound waves within said interior passenger compartment of said motor vehicle and send data signals to said processor member.

12. The combination of claim 11, further comprising a power source located within said interior volume of said main body and is electrically connected with said scanner member, said processor member, said transmitter, and said sound detector member, and is adapted to supply power to said scanner member, said processor member, said transmitter, and said sound detector member when the power source of said motor vehicle is unavailable.

13. The combination of claim 12, wherein said power source includes at least one battery member.

14. The combination of claim 9, wherein said transmitter includes BLUETOOTH technology.

15. The combination of claim 14, wherein said at least one external receiver is formed as a smart phone including BLUETOOTH technology adapted to receive signals from said BLUETOOTH technology of said transmitter.

16. The combination of claim 9, further comprising an alert button located upon said front wall and adapted to send an alert signal to said transmitter to thereby send an alert signal to said at least one external receiver; an on/off button located upon said front wall and adapted to turn said sensory device on or off; and an emergency service button located upon said front wall and adapted to send an emergency service request signal to said transmitter to thereby send an emergency service request signal to an emergency service system.

17. The combination of claim 9, wherein said at least one external receiver is formed as a smart phone that includes a computer application adapted to alert an owner of said motor vehicle that a passenger is in their motor vehicle.
